(19) United States
(12) Patent Application Publication
(10) Pub. No.: US 2015/0267862 A1
(43) Pub. Date: Sep. 24, 2015

(54) ARTICLE HOLDING DEVICE

(71) Applicant: Nathaniel Abram MISHLER, Hickory Corners, MI (US)

(72) Inventor: Nathaniel Abram MISHLER, Hickory Corners, MI (US)

(21) Appl. No.: 14/223,670

(22) Filed: Mar. 24, 2014

(51) Int. Cl. F16M 13/02

(52) U.S. Cl. CPC F16M 13/022

(57) ABSTRACT

An article holder is provided. The article holder may include a body and a plurality of gripping apertures. The body may terminate at a first and a second end. The first end may include at least one gripping aperture. The second end may include at least one gripping aperture. A user may drape the body over a structure, such as a bedrail, a wheelchair handle, a support bar or the like, so that at least one gripping aperture on the first end and at least one gripping aperture on the second end may be operable. For example, the at least one gripping aperture on the first end and the at least one gripping aperture on the second end may be on opposing sides below the bottom of the structure. The user may insert the first end through one gripping aperture on the second end. Then the user may pull the first end or the body near the first end so as to snugly cinch the second end and a portion of the body to the structure. The user may then insert a portion of the article, for example a portable urinal, through one gripping aperture on the first end so that the portable urinal may be removable secured to the structure.

### BACKGROUND OF THE INVENTION

The present invention relates to devices for holding articles and, more particularly, to a device for holding and carrying portable urinals.

Portable urinals are commonly found in places such as medical care facilities where people may be unable to leave their bed. Because there is no convenient place designated for such urinals, they are typically placed on or around the bed, potentially next to food, which creates an unsanitary and messy hazard.

Currently, devices for holding portable urinals are costly, bulky, and not disposable. For medical uses, where sterilization and sanitation is mandated, the cleaning and maintenance of the current non-disposable devices result in unnecessary work and cost for overburdened caretakers, staff and facilities.

As can be seen, there is a need for a cost-effective, easily manufactured disposable holder and carrier of portable urinals.

### SUMMARY OF THE INVENTION

In one aspect of the present invention, an article holder comprises: a planar body of flexible material comprising: a first end forming at least one gripping aperture; and a second end forming at least one gripping aperture, wherein each gripping aperture is configured to receive at least one gripping aperture.

In another aspect of the present invention, a method of holding an article comprises: providing an article holder comprising: a first end forming at least one gripping aperture; and a second end forming at least one gripping aperture, wherein each gripping aperture is configured to receive at least one gripping aperture; providing a structure having a first side and a second side; draping the article holder around the first side so that the first end and the second end extend beyond the second side so that at least one gripping aperture on the first end and at least one gripping aperture on the second end are operable; urging the at least one gripping aperture of the first end through the at least one gripping aperture of the second end; tugging the first end so that the second end and the elongated body snugly cinch about the structure; and placing a portion of the article within the at least one gripping aperture of the first end.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of an exemplary embodiment of the present invention shown in use;

FIG. 3 is a perspective view of an exemplary embodiment of the present invention;

FIG. 4 is a plan view of an exemplary embodiment of the present invention;

FIG. 5 is a plan view of an exemplary embodiment of the present invention;

FIG. 6 is a plan view of an exemplary embodiment of the present invention; and

FIG. 7 is a plan view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an article holder. The article holder may include a body and a plurality of gripping apertures. The body may terminate at a first and a second end. The first end may include at least one gripping aperture. The second end may include at least one gripping aperture. A user may drape the body over a structure, such as a bedrail, a wheelchair handle, a support bar or the like, so that at least one gripping aperture on the first end and at least one gripping aperture on the second end may be operable. For example, the at least one gripping aperture on the first end and the at least one gripping aperture on the second end may be on opposing sides below the bottom of the structure. The user may insert the first end through one gripping aperture on the second end. Then the user may pull the first end or the body near the first end so as to snugly cinch the second end and a portion of the body to the structure. The user may then insert a portion of the article, for example a portable urinal, through one gripping aperture on the first end so that the portable urinal may be removable secured to the structure.

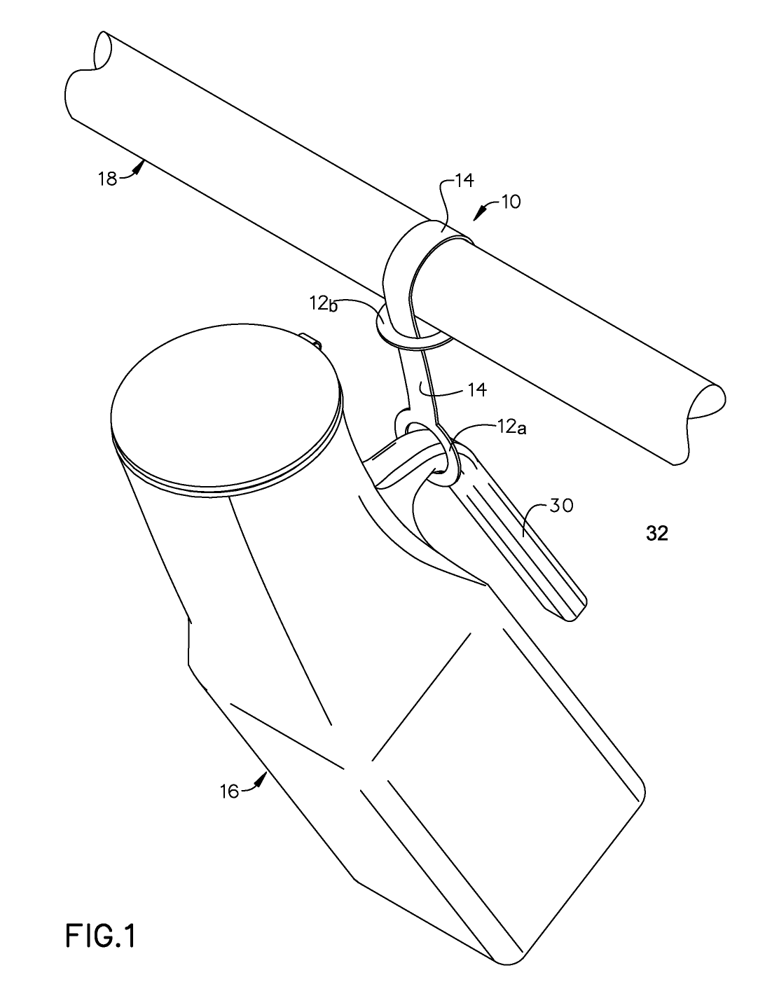

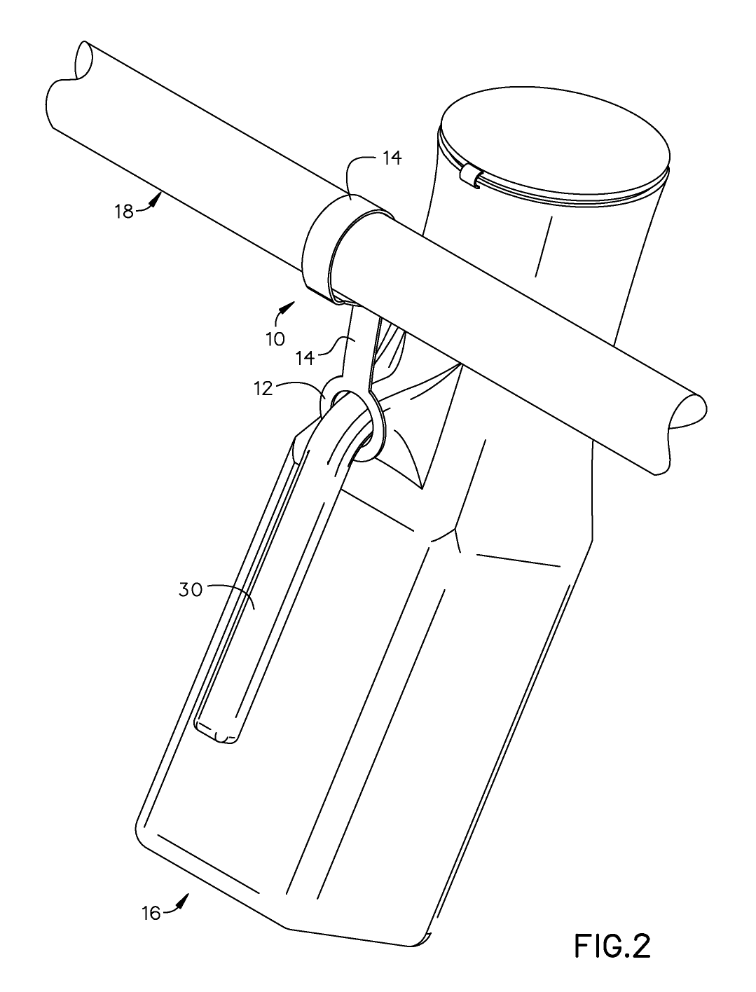

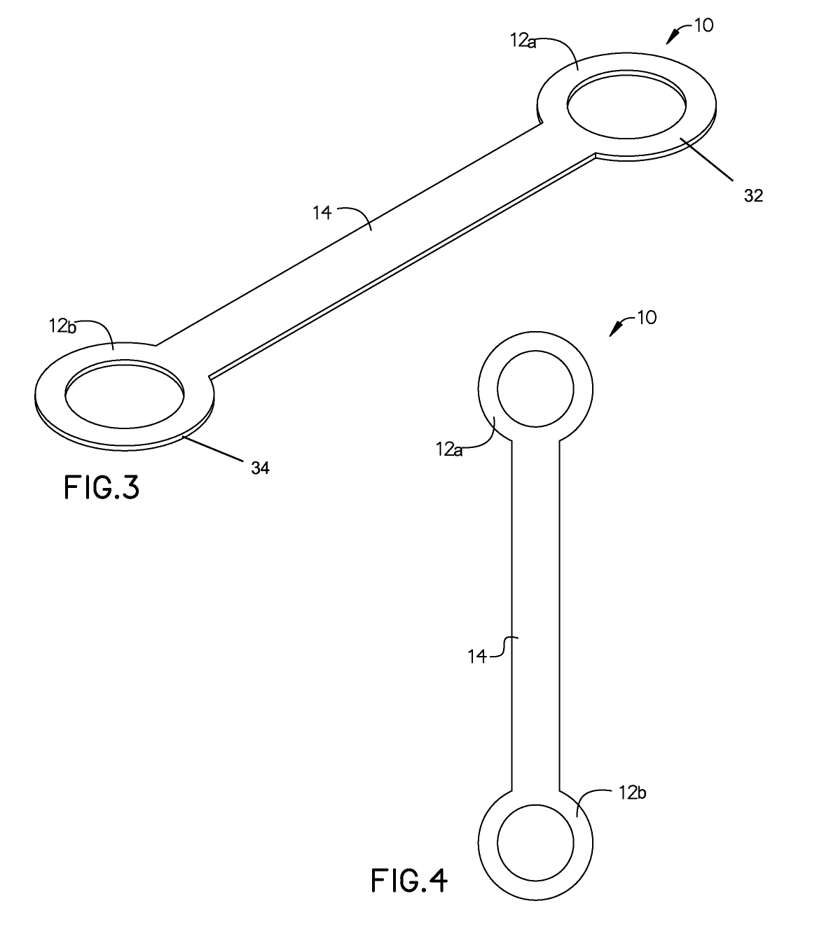

Referring to FIGS. 1 through 7, the present invention may include an article holder 10. The article holder 10 may include a body 14 and a plurality of gripping apertures 12. The article holder 10 may be substantially planar and a unitary construction made from a single sheet of flexible material that may be repeatedly bent without fracturing, such as polyethylene, polypropylene, vinyl, nylon, rubber, leather, wool felt, various plasticized materials and the like. The material may have the strength to hold a plurality of articles 16, yet the flexibility and softness to facilitate the use and installation of the present invention.

The body 14 may have an elongated shape or any other desired configuration, such as but not limited to, oblong, rhombus and the like. The body 14 may have a first end 32 and a second end 34. The first end 32 and the second end 34 may each form at least one gripping aperture 12, as illustrated in FIGS. 1, 3 and 4. The plurality of gripping apertures 12 may be shaped, sized and adapted for receiving and or collaring an article 16, such as but not limited to, a neck, a handle 30 or other grip-able portion of a container. The container may be a portable urinal, milk carton and the like. In certain embodiments, the plurality of gripping apertures 12 may be sized and or shaped to lower the cost and time of mass manufacture, whereby the gripping aperture 12 may be circular, hexagonal, square, octagonal 28 or the like. For example, an alternative article holder 20 may have one gripping aperture 12 that may be a different shape than that of the other gripping aperture 28, as illustrated in FIG. 5.

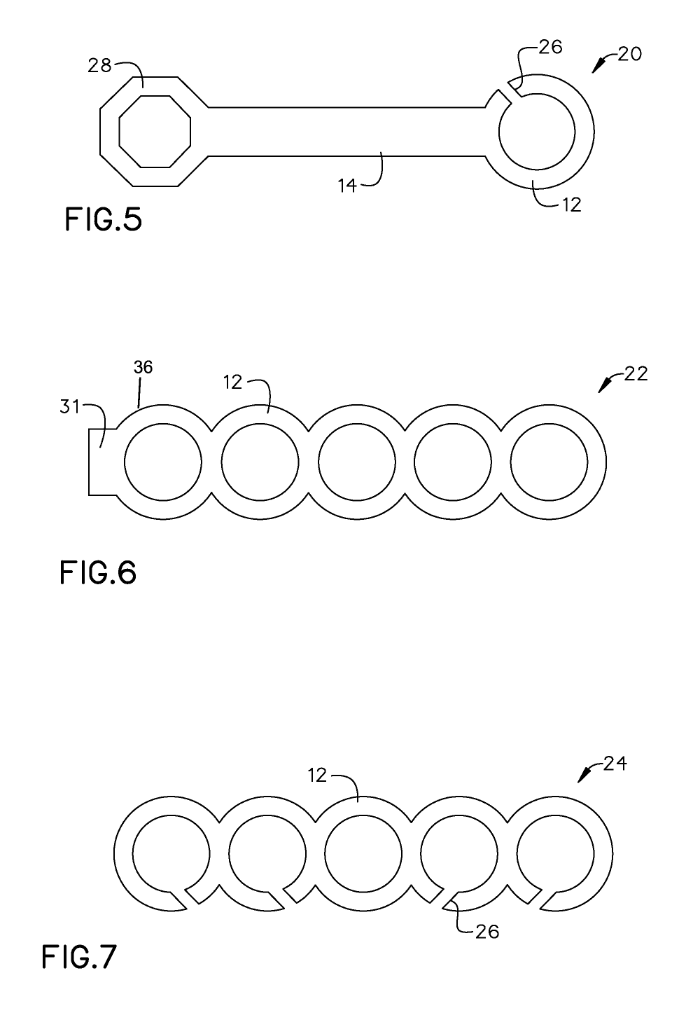

In certain embodiments, the body 14 may form the plurality of gripping apertures 12 along the length of the elongated body 14 so that the plurality of gripping apertures 12 may define a chain-like shape 22, as shown in FIGS. 6 and 7. In an alternate embodiment, the body 14 may form at least one ergonomic tab 31 that may extend from an outer edge 36 of the body 14. The at least one ergonomic tab 31 may be adapted to aid in manipulation and use of the article holder 10.

In certain embodiments, the body 14 may form at least one lead-in slot 26 communicating the outside edge 36 of the body 14 and one gripping aperture 12, as illustrated in FIGS. 5 and 7. The lead-in slot 26 may be adapted to facilitate the reception and or collaring of the article 16. The lead-in slot 26 may be disposed along the gripping aperture 12 so that the article 16 may be secured within the article holder 10 when in use. For example, the angle of at least one lead-in slot 26 relative to the longitudinal body 14 may not exceed negative or positive 45 degrees. In certain embodiments, a differently-slotted article holder 24 may include at least one lead-in slot 26 extending in a direction that is non-parallel relative to other lead-in slots 26 formed within the same body 14, thereby providing a user with different angles of approach when receiving and or collaring the desired article 16.

A method of using the present invention may include the following. The article holder 10 disclosed above may be provided. A user may drape the body 14 over a structure 18, such as a bedrail, a wheelchair handle, a support bar and the like, so that at least two gripping apertures 12 may be operable. For example, a gripping aperture 12a on the first end 32 may be below and on the opposite side of the structure 18 than a gripping aperture 12b on the second end 34, as illustrated in FIG. 1. Then the user may insert the gripping aperture 12a through the gripping aperture 12b, thereby allowing the user to cinch the gripping aperture 12b to a portion of the body 14 so as to snugly secure the article holder 10 to the structure 18. The user may then insert a portion of the article 30, for example, the open handle of a portable urinal through the gripping aperture 12a so that the portable urinal may be removable secured to the structure 18.

In certain embodiments, the user may employ an article holder 10 with at least one lead-in slot 26 so as to secure an article 16 with an inaccessible opening, for example, a closed handle container. So that after cinching the gripping aperture 12 to the body 14, the user may slide the closed handle through the lead-in slot so that when releasing the closed handled container the body 14 supports the weight of such container.

In certain embodiments, the user may employ the chain-like shape 22 article holder 10, whereby the user may choose which of the plurality of gripping apertures 12 to insert the article 16 so as to accommodate for varying weights of the article 16 and or adjust how the article 16 hangs under the influence of gravity. Moreover, the user may hold a plurality of articles 16 when a plurality of gripping apertures 12 may be operable.

From the description above, a number of advantages of some of the embodiments become evident. For example, the sheets that form the planar article holder 10 can be made from cost effective material, whereby a few rolls of it will permit the manufacturer to cost effectively mass produce the entire article holder 10. This lends itself to disposable user, which would be a boon in the medical field where devices are required to be thrown away after one use, or alternatively sterilized through a time and expense consuming process. In certain embodiments, as illustrated in FIG. 5, the shape of the specially shaped article holder 20 may be adapted to make the manufacturing process far more efficient while not detrimentally impacting the operability of the present invention.

It should be understood, of course, that the foregoing relates to exemplary embodiments of the invention and that modifications may be made without departing from the spirit and scope of the invention as set forth in the following claims.

What is claimed is:

1. An article holder comprising:
a planar body of flexible material comprising:
a first end forming at least one gripping aperture; and
a second end forming at least one gripping aperture,
wherein each gripping aperture is configured to receive at least one gripping aperture.

2. The article holder of claim 1 wherein the planar body of flexible material forms at least one lead-in slot extending from an outside edge thereof and communicating with an adjacent gripping aperture.

3. The article holder of clam 1 wherein the plurality of gripping apertures are shaped to minimize the cost of manufacture.

4. An article holder comprising:
an elongated planar body of flexible material defining a plurality of gripping apertures configured sequentially along the length thereof so as to form a chain-like shape, whereby each gripping aperture is configured to receive at least one gripping aperture.

5. The article holder of claim 4, wherein the planar body of flexible material forms at least one lead-in slot extending from an outer edge thereof and communicating with an adjacent gripping aperture.

6. The article holder of claim 4 wherein the planar body forms at least one ergonomic tab.

7. A method of holding an article comprising:
providing an article holder comprising: a first end forming at least one gripping aperture; and a second end forming at least one gripping aperture, wherein each gripping aperture is configured to receive at least one gripping aperture;
providing a structure having a first side and a second side;
draping the article holder around the first side so that the first end and the second end extend beyond the second side so that at least one gripping aperture on the first end and at least one gripping aperture on the second end are operable;
urging the at least one gripping aperture of the first end through the at least one gripping aperture of the second end;
tugging the first end so that the second end and the elongated body snugly cinch about the structure; and
placing a portion of the article within the at least one gripping aperture of the first end.

8. The method of claim 7, wherein the body forms at least one lead-in slot extending from an outer edge thereof and communicating with an adjacent gripping aperture, and further including sliding the portion of the article within the at least one gripping aperture through the lead-in slot.
